(19) United States
(12) Patent Application Publication
(10) Pub. No.: US 2011/0186608 A1
(43) Pub. Date: Aug. 4, 2011

(54) CAR TOP CARRIER LID SUPPORT

(75) Inventors: Chris Sautter, Portland, OR (US); John Mark Elliott, Beaverton, OR (US)

(73) Assignee: Yakima Products, Inc., Beaverton, OR (US)

(21) Appl. No.: 13/018,384

(22) Filed: Jan. 31, 2011

Related U.S. Application Data
(60) Provisional application No. 61/337,024, filed on Jan. 29, 2010.

(51) Int. Cl. B60R 9/00

(52) U.S. Cl. 224/328

(57) ABSTRACT

Strut designs for assisting opening and closing of a cargo box lid are provided. A strut includes two or more arms biased toward one or more directions by spring devices. Struts may be used on a single side opening box or a dual-side opening box, and may exhibit degrees of symmetrical design and movement for balanced operation.

### CROSS REFERENCE TO RELATED APPLICATIONS

This application is based upon and claims priority under 35 U.S.C. §119 from U.S. Provisional Patent Application Serial No. 61/337,024 filed Jan. 29, 2010, which is incorporated herein by reference in its entirety for all purposes

This application also incorporates by reference the following patent and patent applications: U.S. Pat. Nos. 6,918,521, D543,929, 7,416,098, 7,740,157 and U.S. patent application Ser. No. 11/219,578.

### BACKGROUND

Car top carriers have become a common way to transport cargo. Enclosed carriers are preferable over conventional open racks for a variety of reasons. Enclosed carriers protect cargo from the elements such as wind, rain, and snow. Enclosed carriers are also more secure from theft or vandalism. Accordingly, there is continuing need for car top carriers that are reliable, easy to mount on a vehicle, and easy to use.

### DESCRIPTION OF THE FIGURES

FIG. 1 is a perspective view of a car top carrier mounted on a vehicle.

FIG. 2 is a perspective view of the car top carrier shown in FIG. 1, with the lid in an open position.

FIGS. 3A-3C are end views of a car top carrier or box (shown in dashed lines), including a lid support or strut shown in opened and closed positions.

FIG. 4 is an exploded view of the strut shown in FIGS. 3A-3C.

FIG. 5 is a front view of an alternative strut with various positions shown in dashed lines.

FIG. 6 is a front view of an alternative strut with various positions shown in dashed lines.

FIG. 7 is a front view of an alternative strut with various positions shown in dashed lines.

FIG. 8 is a front view of an alternative strut with various positions shown in dashed lines.

FIG. 9 is a front view of an alternative strut with various positions shown in dashed lines.

FIG. 10 is a front view of an alternative strut with various positions shown in dashed lines.

FIG. 11 is a front view of an alternative strut embodiment in a closed position, with an overlaid open position shown in dashed lines.

FIG. 12 is an exploded view of the strut shown in FIG. 11.

FIG. 13 is a partial close-up cutaway view of a spring adjustment device on the lid support shown in FIGS. 11 and 12.

FIG. 14 is a front view of the spring adjustment device illustrated in FIG. 13.

FIG. 15 is a partial perspective view of a pivot coupling on the strut shown in FIGS. 11 and 12.

FIG. 16 is a partial perspective view of another pivot coupling in the strut shown in FIGS. 11 and 12.

FIG. 17 is a series of front views of a strut device in a progression of orientations between open and closed positions.

FIG. 18 is a graph illustrating the relationship of lift force versus the angle between long links in a strut such as the strut shown in FIG. 11.

FIG. 19 is a graph illustrating the relationship between lift force and the extension of a strut such as strut 400 as shown in FIG. 11.

FIG. 20 is a partial sectional view through a box, illustrating mounts for connecting a strut to a bottom portion and a lid of a cargo carrier.

FIG. 21 is a partial cutaway perspective view of a strut connecting a bottom portion to a lid of a cargo carrier.

FIG. 22 is a perspective interior view of a strut mounted on the inside of a cargo carrier.

### DETAILED DESCRIPTION

A number of different car top carrier configurations and strut designs are described in detail below. It will be apparent that many other variations of the described configurations are envisioned and enabled. Car top carriers may be provided in many different forms. For example car top carriers may be configured for mounting on a pair of cross bars on top of a vehicle. Car top carriers often have a bottom portion and a lid portion. The bottom portion and lid portion may be hinged along one or more edges so that the carrier may be opened for loading and accessing cargo inside the carrier, and closed for securing cargo during transport.

Car top carriers often have a generally elongate or rectangular shape with rounded or curved contours to achieve a generally aerodynamic configuration. Top portions or lids may be hinged along a front edge, a rear edge, or one or both lateral sides. Hinges of different forms may be used. For example, one or more typical door-style hinges may be provided on one or more sides of the carrier. Alternatively, hinges which may dually function as a latch may also be used so that a carrier may be alternately, opened on more than one side. Examples of hinge/latch assemblies may be found in U.S. Pat. No. 7,416,098 and application Ser. No. 12/494,218, each of which is hereby incorporated by reference. Car top carriers may also include one or more latch systems which provide a locking device for securing a carrier in its closed position to prevent removal of cargo from the carrier. For example, a locking latch system is shown in U.S. patent application Ser. No. 12/494,218, which is hereby incorporated by reference.

Car top carriers may include one or more lid supports or strut devices for supporting and coordinating sides of the lid as it opens from its closed position. Struts may also function to provide an opening force to the lid as it moves from its closed position to the open position, and to hold the lid in its open position when cargo is being loaded or accessed from the interior compartment of the carrier.

Lid supports may take various forms including assemblies of multiple arms, pivot devices, and spring elements. For example, lid supports may use a pair of arms, one arm being pivotally attached to the lid, the other arm being pivotally attached to the base of the carrier, the two arms being pivotally attached to each other, and a spring device provided to urge the arms toward an open position. Other lid support embodiments may take the form of four bars, two upper bars pivotally connected to each other and to the lid, the other two bars being pivotally attached to each other and to the bottom portion, each pair of arms being pivotally attached to the other pair, with a spring device configured to urge the lid support toward an open position.

Lid supports may be configured to provide an upward, or opening force over the entire range of lid support movement from closed to open positions. This type of lid support may be described as a single-force lid support. Alternatively, a lid support may be provide opposite opening and closing forces over a range of movement between open and closed positions. For example, a lid support may be configured to provide an opening force through most of its range of movement, while providing a closing force when the lid is close to its closing position. This type of lid support may be described as a dual-force lid support.

Cargo carriers may have dual functioning latch/hinge assemblies on opposing sides of the carrier which allow the lid to be opened from more than one side of the carrier. This type of carrier may be described as a dual-side opening carrier. It may be desirable in some configurations of dual-side opening carriers for the one or more lid supports to have a generally symmetrical configuration with respect to each opening side of the carrier.

Different carrier designs may require different lid support configurations and specifications. For example, various carriers are made of different materials having different dimensions and weights. The amount of opening or closing force desired for different carrier configurations may vary. Therefore, it may be desirable to use different kinds of springs, different sizes of springs, or mounting configurations which allow adjustment of a spring's force effect on a given strut assembly.

The drawings and description below provide specific examples of strut assemblies for car top carriers.

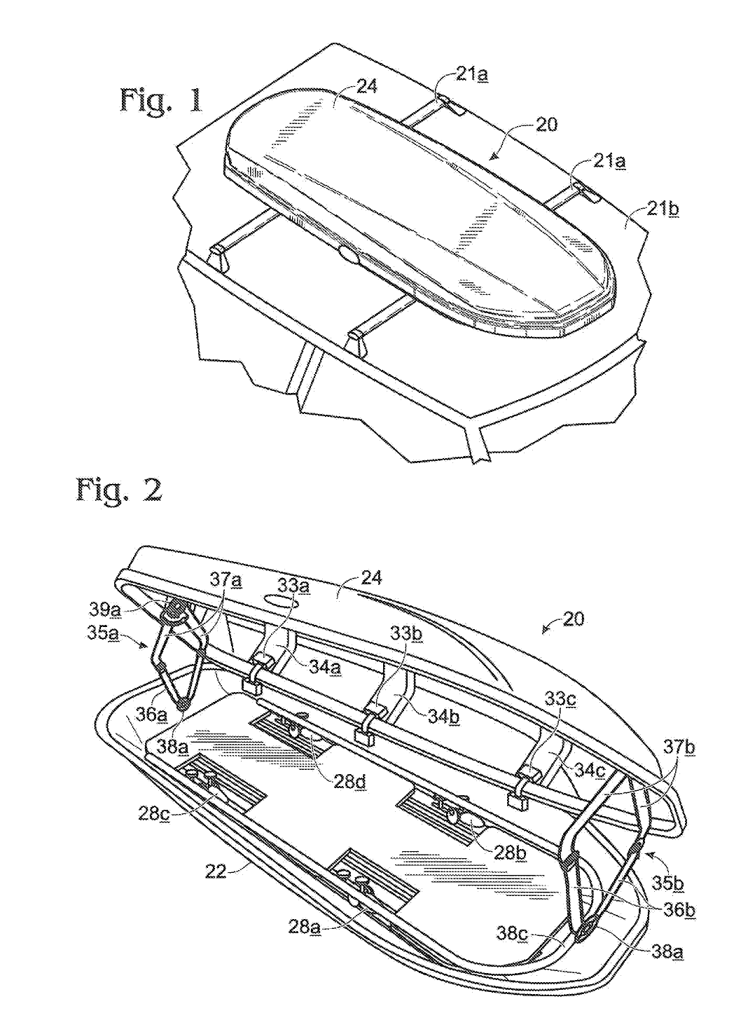

FIG. 1 shows car top carrier 20 mounted on a pair of cross bars 21a which are mounted on vehicle roof 21b. FIG. 2 shows car top carrier 20 in an open position. Car top carrier 20 includes bottom portion 22 connected to top portion or lid 24. In FIG. 2 lid 24 is hinged for opening and closing to bottom portion 22. Clamp devices 28a-d are provided on bottom portion 22 for fastening carrier 20 on cross bars 21a. A plurality of hinge devices 33a, 33b, and 33c connect bottom portion 22 to lid 24. Side-to-side bridging structures 34a, 34b, 34c are mounted on an interior surface of lid 24, and are substantially aligned with hinge members 33a, 33b, and 33c. Strut assemblies 35a and 35b are provided on opposite ends of carrier 20. Struts 35a and 35b connect bottom portion 22 to lid 24. Strut 35a includes lower arms 36a which are pivotally connected to upper arms 37a. Lower arms 36a are pivotally connected at point 38a to a wall of bottom portion 22. Upper arms 37a are pivotally connected at point 39a to lid 24. Similarly, strut 35b includes lower arms 36b which are pivotally connected to upper arms 37b. Lower arms 36b are pivotally connected at 38a to bar structure 38c which is rigidly connected to bottom portion 22. Upper arms 37b are pivotally connected to lid 24 at a point which cannot be seen in FIG. 2.

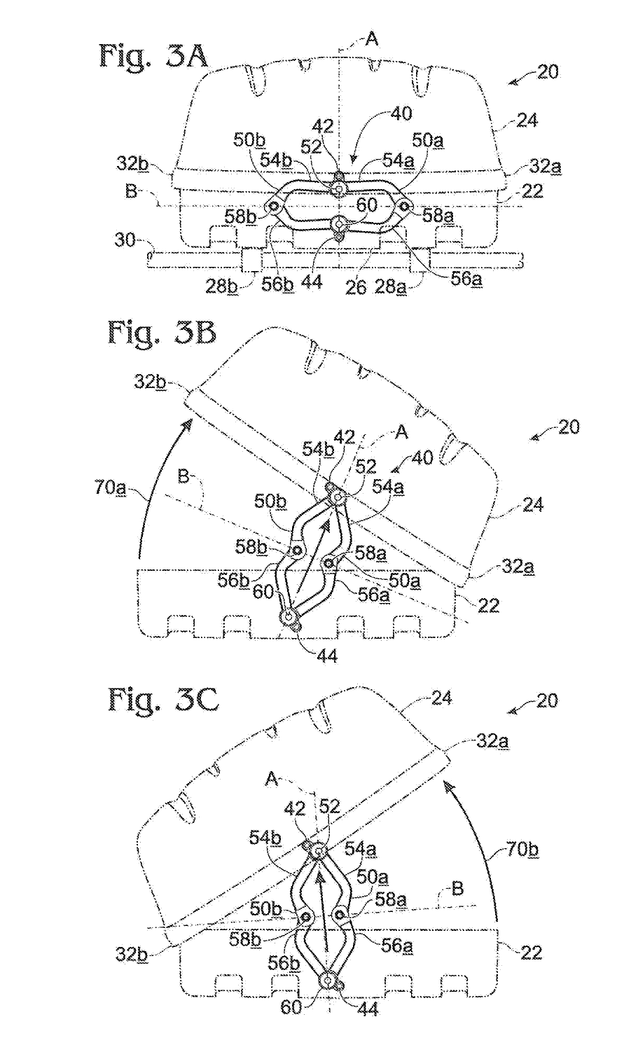

FIGS. 3A-3C show a strut configuration used on a dual-side opening box 20. Box 20 includes bottom portion 22 connected to lid portion 24. Bottom portion 22 has a bottom side 26 equipped with clamps 28a, 28b for fastening box 20 to crossbar 30 on the top of the vehicle (not shown). Typically, crossbar 30 would be one of two parallel crossbars connected across the roof of a vehicle via a pair of towers which secure crossbar 30 to the vehicle via any number of various fastening arrangements, for example, factory-provided mounts, longitudinal rails, rain gutters, etc. Another pair of clamps such as clamps 28a, 28b would be provided near the other end of box 20 for fastening box 20 to the other crossbar (not shown).

Lid portion 24 is releasably fastened to bottom portion 22 along sides 32a and 32b via hinge/latch assemblies which enable opening of lid portion 24 on either side, as shown in FIGS. 3B and 3C.

Struts, such as strut 40, are provided on at least one end, or preferably both ends, of box 20 for assisting with opening and/or closing of lid portion 24 relative to bottom portion 22. Strut 40 is pivotally connected, via bolts, screws, rivets, or other suitable fastening means to lid portion 24, and bottom portion 22 at pivot points 42 and 44, respectively.

Strut 40 includes two arm assemblies 50a, 50b cooperatively connected, and symmetrically assembled relative to perpendicular axes A and B. Arm assemblies 50a, 50b are connected via a shared shoulder pivot 52. Arm assembly 50a includes upper arm portion 54a extending from shared shoulder pivot 52 and is connected to lower arm portion 56a via elbow pivot 58a. Lower arm portion 56a then connects to shared wrist pivot 60. Similarly, arm assembly 50b includes upper arm portion 54b extending from shared shoulder pivot 52. Upper arm portion 54b is connected to lower arm portion 56b via elbow pivot 58b, then connecting to shared wrist pivot 60.

Force devices, for example, coiled torsion springs, are used in shared shoulder and wrist pivots 52, 60 for creating an upward force on lid portion 24, in the directions of arrows 70a, 70b in FIGS. 3B and 3C, for assisting with opening of lid portion 24 relative to bottom portion 22. Various alternative spring configurations may be employed to modify the force characteristics of strut 40. For example, one or more torsion springs may be positioned additionally or alternatively at any one, or any combination of, pivots 52, 60, 58a, 58b. Alternatively, coiled tension springs may be used between arm assemblies 50. Coiled tension springs may be used between arm assemblies 50a, 50b to bias the arm assemblies toward each other causing lid portion 24 to be urged upward on FIGS. 2 and 3.

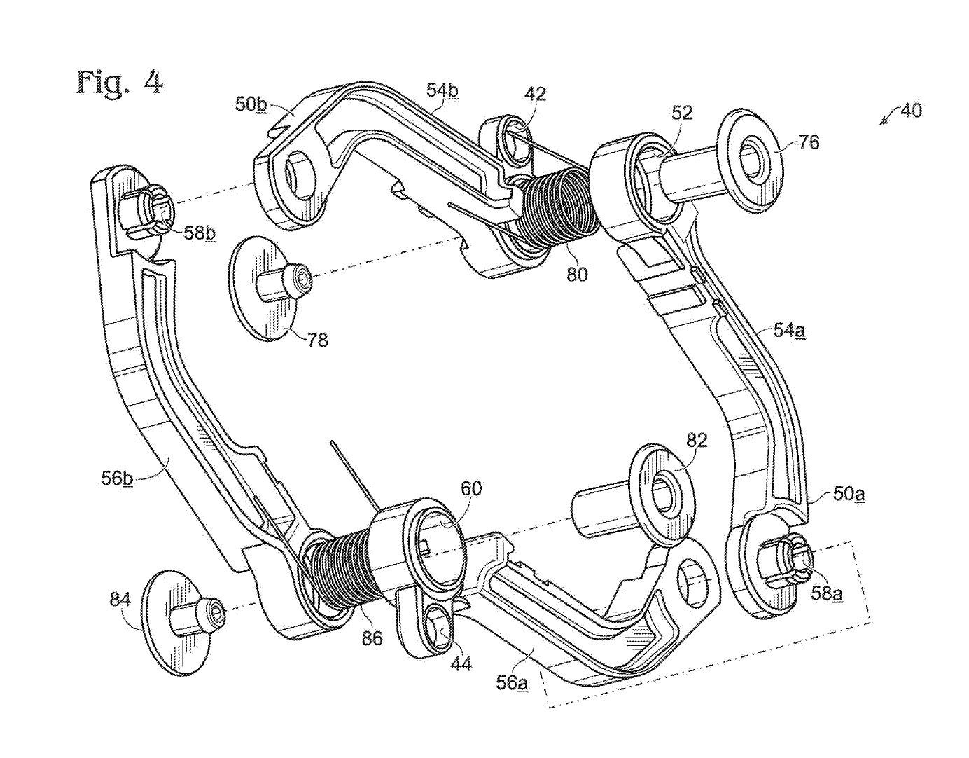

FIG. 4 shows an exploded view of strut 40. Upper arm portion 54a is connected to upper arm portion 54b at shared shoulder pivot 52. Shoulder pivot 52 is secured by coupling snap-rivet 76, 78. Coil spring 80 is positioned in shoulder pivot 52 to urge upper arm portions 54a, 54b toward each other, thus biasing lid portion 24 to an open position.

Similarly, lower arm portion 56a is connected to lower arm portion 56b at shared wrist pivot 52. Wrist pivot 52 is secured by coupling snap-rivet 82, 84. Coil spring 86 is positioned in wrist pivot 52 to urge lower arm portions 56a, 56b toward each other, thus biasing lid portion 24 to an open position.

Upper arm portions 54a, 54b are connected to lower arm portions 56a, 56b via elbow pivots 58a, 58b, respectively. In the example shown in FIG. 4, elbow pivots 58a, 58b are merely unbiased pivotal connections between the upper and lower arm portions. However, it may be possible to incorporate biasing components, such as springs, cams, or stops, in the elbow joints, or shoulder or wrist joints, for purposes of limiting or assisting strut movement, or limiting the force profile of the strut as it moves between open and closed positions.

Strut 40 is constructed from pairs of identical parts. For example, upper arm portion 54a is the same as lower arm portion 56b. Upper arm portion 54b is the same as lower arm portion 56a. Springs 80 and 86 are identical. Rivet members 76, 78 are the same as rivet members 82, 84, respectively. The part pairing configuration is advantageous for manufacturing simplicity and consistency.

As shown in FIGS. 3A-3C, strut 4 operates in a symmetrical manner relative to axes A and B. The operation of strut 40 is considered to be symmetrical even though the fine detail of upper arm 54a is equivalent to lower arm 56b and the fine detail of upper arm 54b is equivalent to lower arm 56a. The basic structural forms of the arms are the same providing equivalent operational assist function for opening the box from either side.

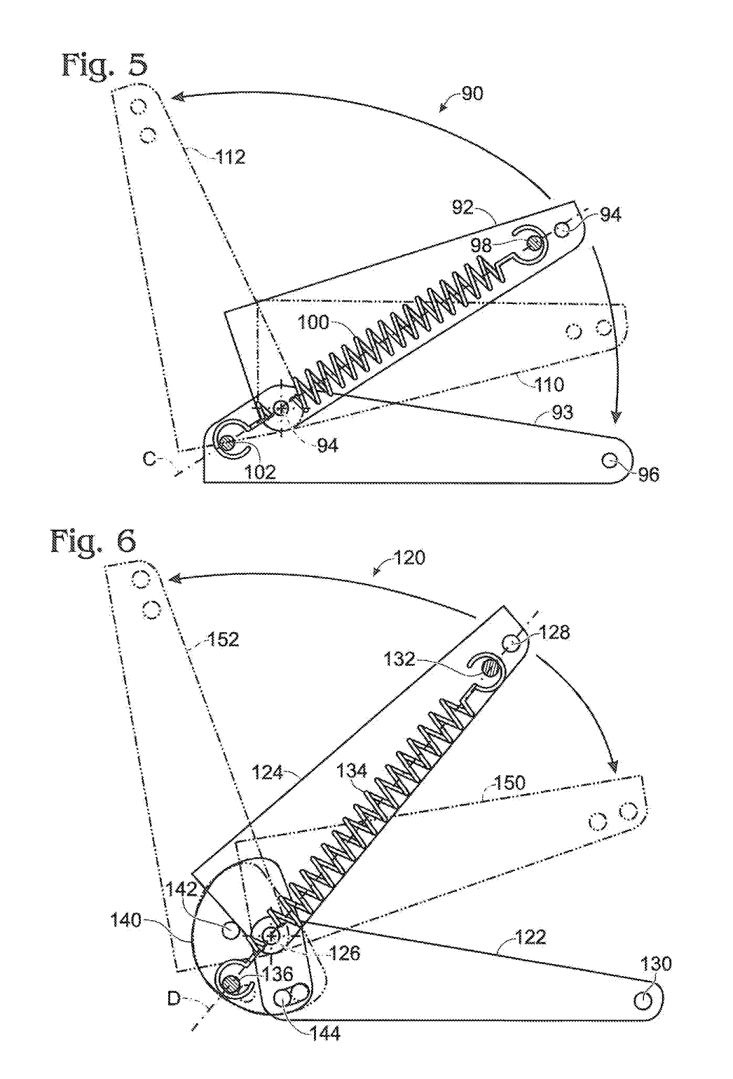

FIG. 5 shows another strut embodiment 90 including upper arm 92 pivotally connected to lower arm 93 at pivot point 94. Upper arm 92 has aperture 94 near a distal end for attaching upper arm 92 to a lid portion of a cargo box. Lower arm 93 has aperture 96 near its distal end for attaching lower arm 93 to a bottom portion of the cargo box. Upper arm 92 has a peg or post structure 98 for retaining an end of tension spring 100. The other end of tension spring 100 is hooked to peg or post structure 102 on lower arm 93. Line C passes through peg structure 98 on upper arm 92 and through pivot point 94. As upper arm 92 moves downward, for example, in the position as shown at 110, spring 100 urges upper arm 92 toward a closing position relative to lower arm 93. Alternatively, as upper arm 92 moves upward, for example, as shown by upper arm position 112, spring 100 urges upper arm 92 toward an open position. This strut may be referred to as a dual-force strut, which may be useful on a cargo box design which is desirable to urge the lid in opposite directions depending on where the lid is positioned along its range of motion between opening and closing. It is sometimes desirable to have the lid urged toward closing as the lid becomes close to the bottom portion of the box, while exerting an opening force across the lid's upper range of movement. In the example shown in FIG. 5, this is accomplished by moving spring 100 back and forth across line or axis C which connects posts 98 and pivot point 94.

FIG. 6 shows another example of a strut for biasing upward movement of a lid on a cargo box. Strut 120 includes upper arm 124 pivotally connected to lower arm 122 at pivot point 126. Upper arm 124 has aperture 128 for connecting upper arm 124 to a cargo box lid. Lower arm 122 has aperture 130 near its distal end for attaching lower arm 122 to a bottom portion of a cargo box. Upper arm 124 has a peg or post structure 132 for retaining one end of tension spring 134. The other end of tension spring 134 is hooked around peg or post structure 136 on rocker member 140. Rocker member 140 is pivotal around pivot point 126, and may be sandwiched between upper and lower arms 122, 124, or may be stacked on one side of the two arms. Rocker member 140 includes pegs 142, 144 for stopping movement relative to arms 122, 124, thus linking movement of the arms relative to tensioning force of spring 134. Line D connects peg 132 to pivot point 126. As upper arm 124 moves toward position 150, in a closing direction of the lid, spring 134 moves below line D, thus urging the lid toward closing. Alternatively, as arm 124 moves toward position 152, spring 134 moves upward, or to the left in FIG. 6 of axis D, thereby exerting an opening or upward force on the lid of a cargo box. Similar to the strut shown in FIG. 5, strut 120 is configured to function as a dual-force strut.

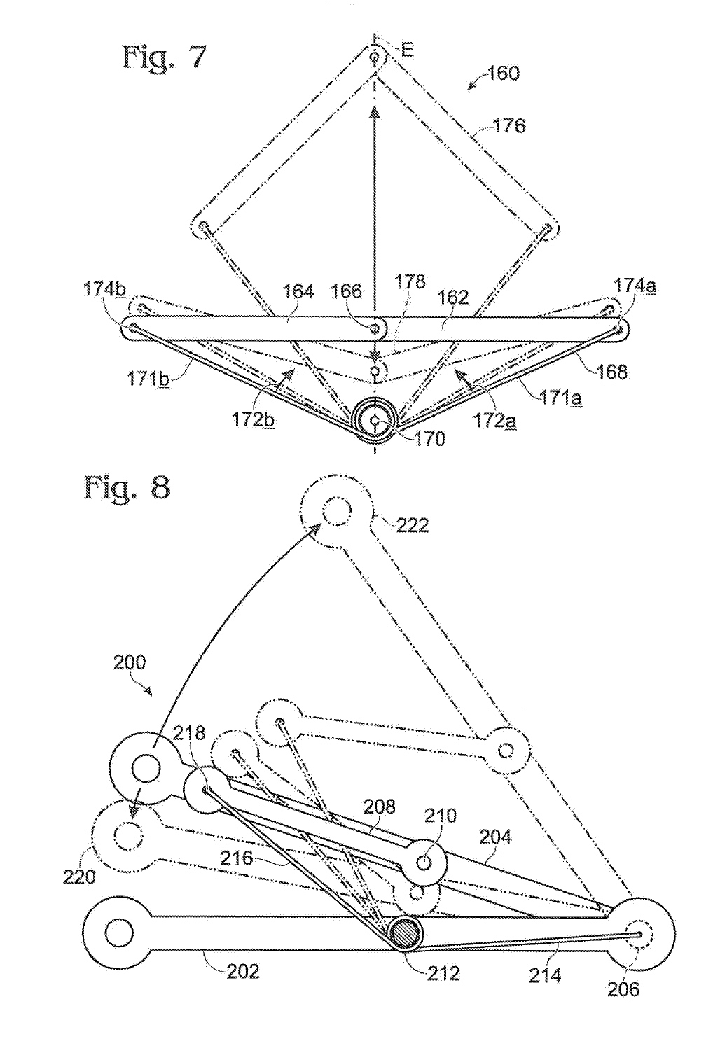

FIG. 7 shows another strut example. Strut 160 includes bars 162, 164 connected to pivot point 166. Pivot 166 may be connected to a point inside the lid of a cargo box. Spring 168 is pivotally mounted on the inside of the bottom portion of a cargo box at point 170. Spring 168 has arms 171a, 171b which are biased in the directions of arrows 172a, 172b, respectively. Distal ends of arms 171a, 171b are connected to distal ends 174a, 174b of bars 162, 164, respectively. As shown in FIG. 7, as bars 162, 164 move toward position 176 (lid opening), an upward force is exerted on the lid of a cargo box. Alternatively, as bars 162, 164 move downward toward position 178, a downward force may be exerted on the lid of a cargo box. Similar to the strut shown in FIGS. 1-4, strut 160 is symmetrical relative to axis E, and relative to alternating dual side opening positions on the cargo box.

FIG. 8 shows another strut embodiment. Strut 200 includes bars 202, 204 pivotally connected at pivot point 206. A third bar 208 is pivotally connected at point 210 along bar 204. Spring 212 is mounted at a point along bar 202. Spring 212 has arms 214, 216. The distal end of spring arm 214 is mounted at or near pivot point 206. The distal end of arm 216 is mounted at or near a distal end 218 of bar 208. Spring 212 is biased to urge arms 214, 216 toward each other. As arm 204 moves toward position 220, shown in dashed lines, bar 208 moves upward, thereby transferring closing force of spring 212 to urge bar 204 downward bringing a cargo box lid toward closing position. Alternatively, as bar 204 moves upward toward position 222, shown in dashed lines, bar 208 moves downward or to the left of bar 204, thus allowing closing movement of spring 212, which translates to opening force being exerted on the lid of a cargo box.

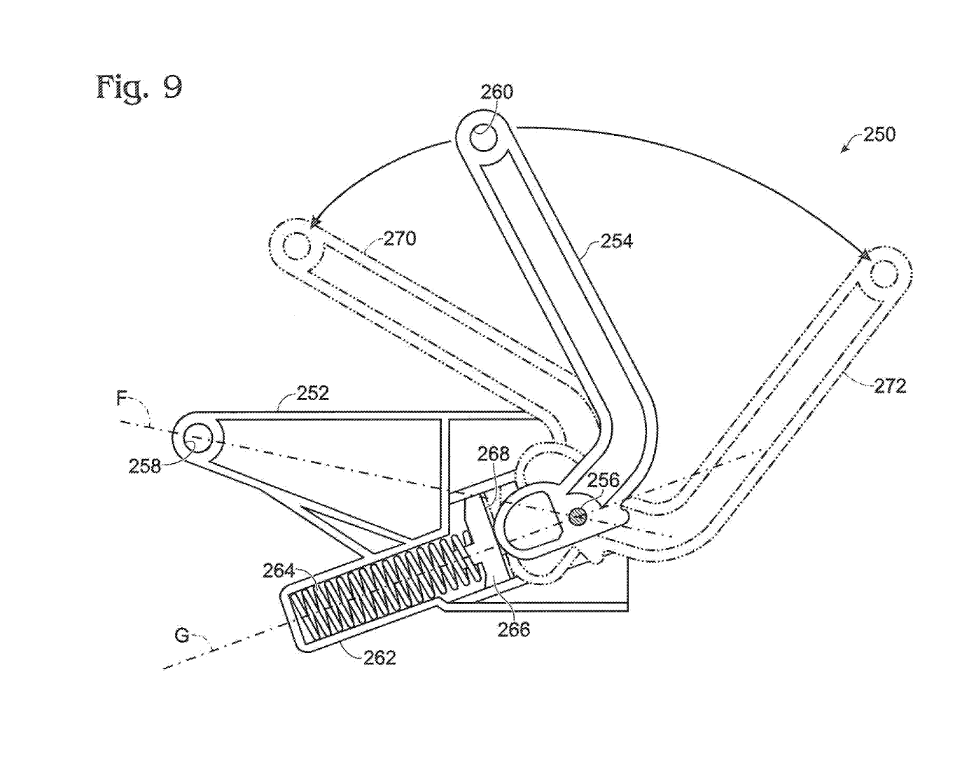

FIG. 9 shows another embodiment of a strut for biasing opening and closing movement of a cargo box lid. Strut 250 includes lower arm 252 pivotally connected to upper arm 254 at pivot point 256. Lower arm 252 has aperture 258 for connecting lower arm 252 to a bottom portion of a cargo box. The distal end of upper arm 254 has aperture 260 for connecting upper arm 254 to a lid on a cargo box. Lower arm 252 has a pocket 262 for holding coiled tension spring 264. Follower 266 engages spring 264 and is movable along axis G, and is biased against cam surface 268 on arm 254. As arm 254 moves toward position 270 (closing direction), the point of contact between cam surface 268 and follower 266 moves to the right of axis G, thereby urging arm 254 toward closing. Alternatively, as arm 254 moves toward position 272 (opening direction), the contact point between cam surface 268 and follower 266 moves to the left of axis G, thereby exerting an opening force on arm 254. The contact point between cam surface 268 and follower 266 does not cross axis F (connecting pivot point 258 to pivot point 256) as arm 254 moves between the open and closed position.

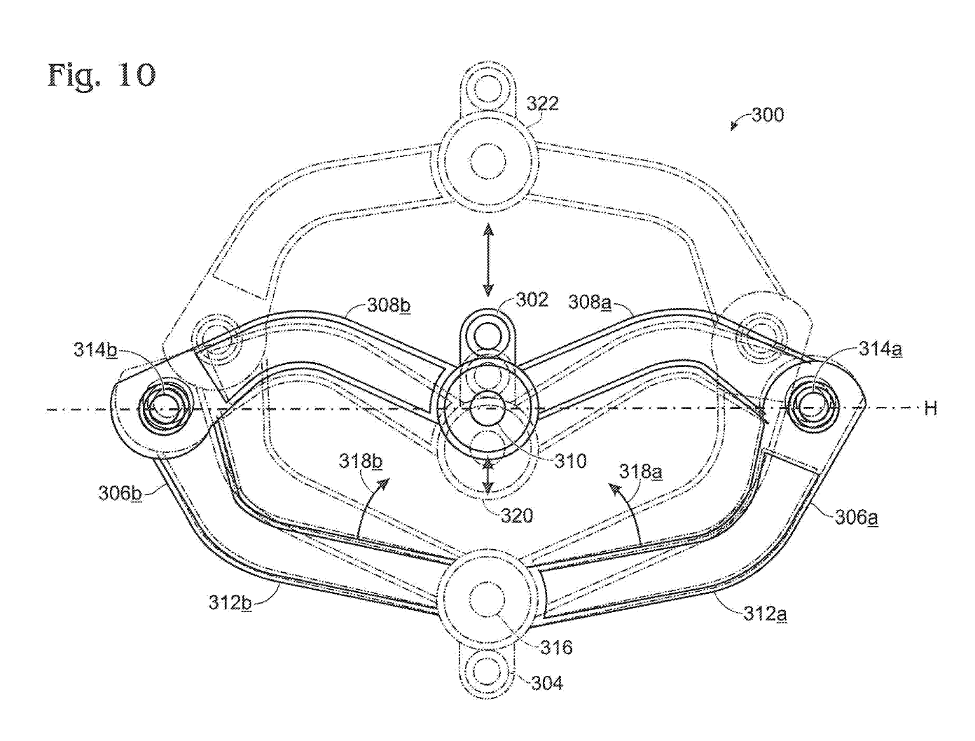

FIG. 10 shows another strut example. Strut 300 in many respects is similar to the strut shown in FIG. 4, however, it is modified to provide alternating, opening and closing, forces on the lid of a cargo box. Strut 300 has apertures 302, 304 for mounting strut 300 on a cargo box lid and bottom, respectively. Strut 300 includes similar or identical arm assemblies 306a, 306b. Arm assemblies 306a, 306b include upper arms 308a, 308b pivotally connected at shoulder pivot 310. Upper arms 308a, 308b are pivotally connected to respective lower arms 312a, 312b at elbow pivots 314a, 314b. Lower arms 312a, 312b are pivotally connected at shared wrist pivot 316. A torsion spring (not shown) is positioned at shared wrist pivot 316, applying equal forces on lower arms 312a, 312b in the direction of arrows 318a, 318b. As upper arms 308a, 308b move downward (closing direction) toward position 320, shown in dashed lines, lower arms 312a, 312b move toward each other, thereby applying a closing force on a lid of a cargo box. Alternatively, as upper arms 308a, 308b move upward (opening direction) toward position 322, shown in dashed lines, lower arms 312a, 312b move toward each other, thereby applying an opening force on the lid of a cargo box. The degree, extent, or proportion of opening and closing forces exerted by strut 300 may be altered by varying the relative lengths or shapes of the arms. For example, as shown in FIG. 10, upper arms 308a, 308b are shorter than respective lower arms 312a, 312b.

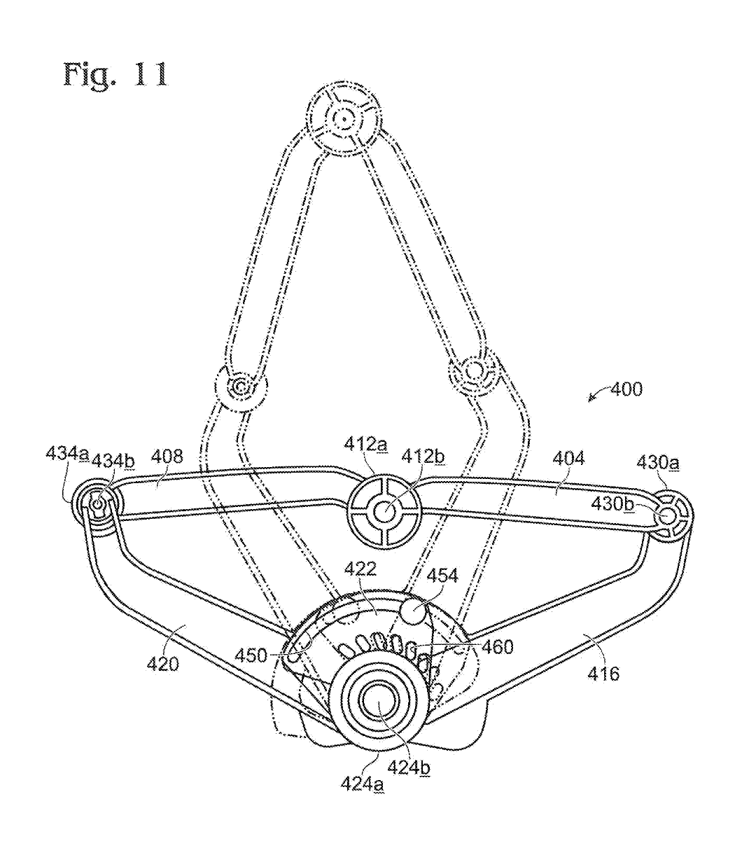

FIG. 11 shows another example of a strut or lid support assembly 400 for mounting and coordinating movement between a bottom portion and a lid of a cargo carrier. Upper arms 404 and 408 are pivotally connected at coupling or pivot junction 412a which defines pivot axis 412b. Lower arms 416 and 420 are pivotally connected at coupling or pivot junction 424a which defines pivot axis 424b. As shown in FIG. 11, arms 416 and 420 are bent near their distal ends. Upper arm 404 is pivotally connected to lower arm 416 at junction 430a which defines another pivot axis 430b. Similarly, on the other side of strut 400, upper arm 408 is pivotally connected to lower arm 420 at junction 434 which defines another pivot axis 434b. Lower arm 420 is rigidly connected to wall 422. Wall 422 includes arc-shaped slot 450. Peg 454 is rigidly connected to arm 416 and slides inside slot 450. The length of slot 450 defines the range of pivotal movement allowed between the four arms and four pivot junctions. Windows 460 are provided in wall 422 which permit viewing of the position of an internal spring. The internal spring may be set at different positions to provide different spring forces to strut 400. Windows 460 allow the user to see which force level the spring has been set to. As shown in FIG. 11, strut 400 is shown in a closed position in solid lines. Strut 400 is shown in an open position in dashed lines. In a preferred embodiment, the spring (not shown in FIG. 11) is configured to force upper arms 404 and 408 upward toward the open position over at least most of the range of movement allowed by slot 450. The shape of the arms and the length of slot 450 may also be configured to provide some degree of closing, i.e., downward, force when strut 400 is near the closed position, thus providing a dual-force strut.

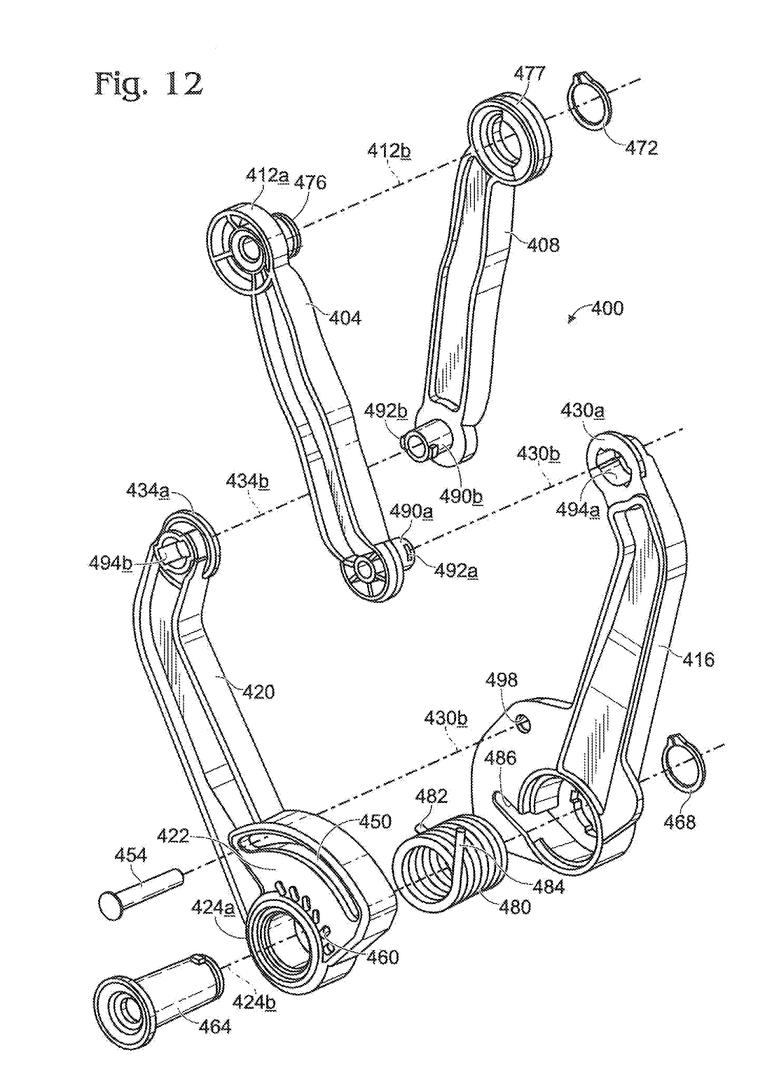

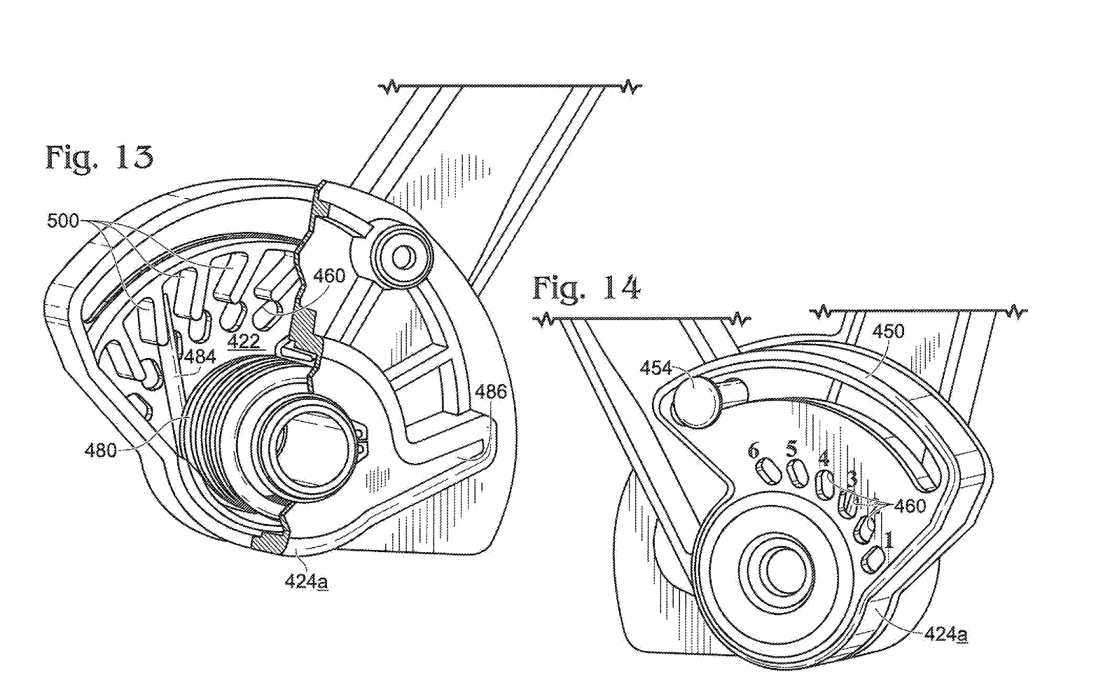

FIG. 12 shows an exploded view of strut 400. Upper arms 404 and 408 are pivotally attached at junction 412a to permit pivotal movement around axis 412b. Lower arms 416 and 420 are pivotally attached at junction 424a to permit pivotal movement of the lower arms around pivot axis 424b. Upper arm 408 is pivotally attached to lower arm 416 at junction 430a to permit pivotal movement between the arms around pivot axis 430b. Similarly, upper arm 404 is pivotally connected to lower arm 420 at junction 434a to permit pivotal movement between the arms around axis 434b. Coupling insert 464 passes through junction 424a including lower arms 416 and 420. Retaining ring 468 is fastened at one end of coupling insert 464 which holds the arms together at junction 424a. Retaining ring 472 is similarly attached to protruding insert 476 after it passes through upper ring portion 477 of upper arm 408, thereby functioning to hold together the upper arms at junction 412a. Spring 480 is provided and contained inside pivot junction 424a. Spring 480 has end portions 482 and 484. End portion 482 is seated in slot 486 of arm 416. Other end portion 484 may be positioned in one of multiple slots provided on the other side of wall 422 (not shown in FIG. 12) to provide different magnitudes of spring force. The slots on the other side of wall 422 (see FIG. 13) correspond with windows 460. Upper arm 404, at its distal end, includes axle portion 490a. Axle portion 490a has one or more flange portions 492a which allow keyed insert through notches 494a and junction 430a. When all four arms are fully assembled, flanges 492a are prevented from aligning with slots 430a, thus preventing disassembly of junction 430a, i.e., uncoupling of upper arm 404 from lower arm 416. Similarly, upper arm 408, at its distal end, has axle portion 490b. Axle portion 490b has one or more flanges 492b which are configured for inserting through recesses or slots 494b of junction 434a. When strut 400 is fully assembled, flanges 492b are prevented from aligning with slots 494b, thus preventing disassembly of the strut, i.e., uncoupling of upper arm 404 from lower arm 420. Pin 454 passes through slot 450 of arm 420, and through hole 498 of arm 416. Accordingly, peg or pin 454 stays fixed with respect to arm 416. However, it is permitted to move in slot 450. Therefore, the dimension of slot 450 defines the permitted range of movement between the arms of strut assembly 400.

FIG. 13 shows strut junction 424a with a section removed revealing slots 500 for receiving end portion 484 of spring 480. Positioning of end portion 484 in different slots 500 allows adjustment of the force exerted on the arms of strut 400 by spring 480. Windows 460 permit viewing, from outside wall 422, of which slot the spring is indexed to. FIG. 13 also shows slot 486 which receives the other end portion 482 of spring 480. FIG. 14 shows the other side of pivot junction 424a, and features which have been previously described above.

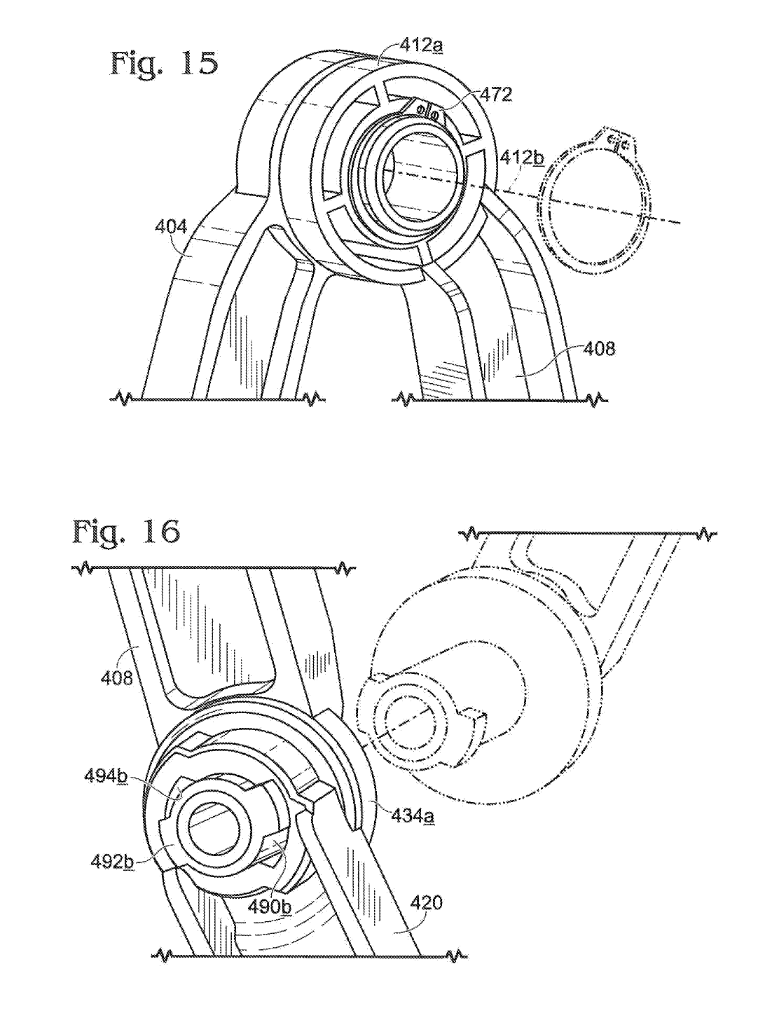

FIG. 15 shows a close up view of pivot junction 412a which is pivotally attached to a lid of a cargo carrier (not shown in FIG. 15). Retaining ring 472 is used to hold together upper arms 404 and 408 in upper pivoting junction 412a while permitting pivotal movement around axis 412b.

FIG. 16 shows pivot junction 434a. Distal ends of upper arm 408 and lower arm 420 are joined by inserting axle portion 490b through a hole in arm 420. Flange portions 492b are inserted through notches or recesses 494b. The arms are then twisted so that flanges 492b are out of alignment with notches 494b, thus locking legs 408 and 420 together. When the entire strut is assembled, flanges 492b are prevented from aligning with recesses 494b, thus preventing arms 408 and 420 from disengaging.

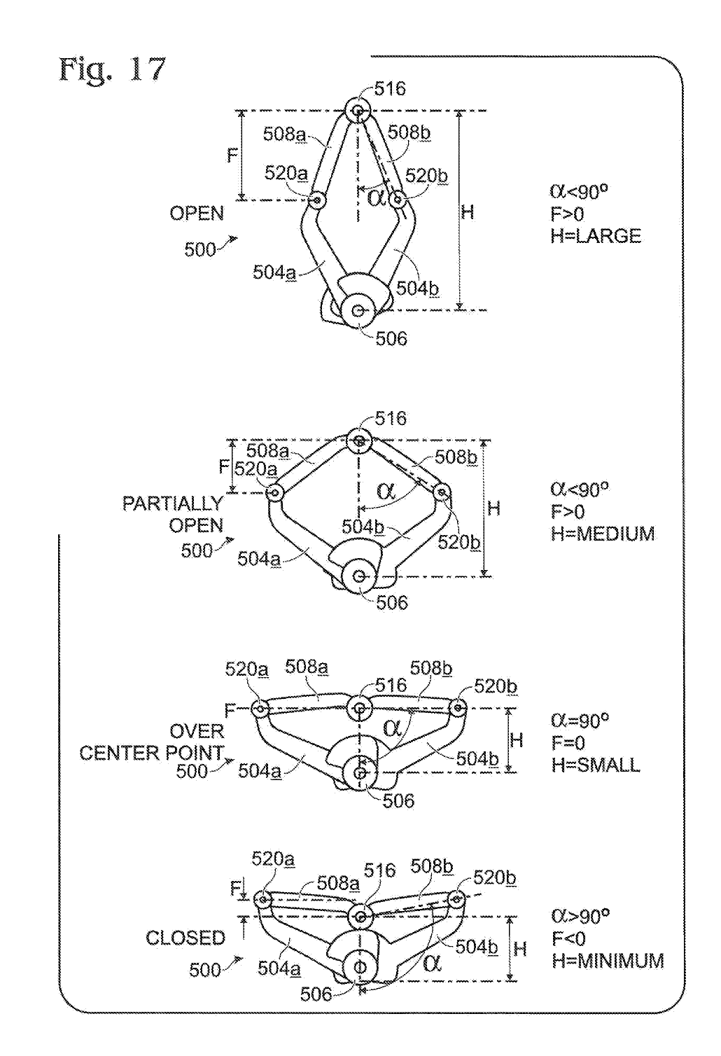

FIG. 17 shows a series of views of strut 500 moving from the open position at the top of the figure, to a closed position at the bottom of the figure. In the first view, strut 500 is in the open position. Lower arms 504a and 504b are pivotally connected to each other at pivot junction 506. Upper arms 508a and 508b are pivotally connected at pivot junction 516. Lower arms 504a and 504b are pivotally connected to respective upper arms 508a and 508b at articulating junctions 520a and 520b. In the first view, strut 500 is maximally extended, meaning that junction 506 and junction 516 are relatively far apart. Angle a is less than 90 degrees. Height H is large compared to other positions in the allowed range of movement. Force F is greater than zero, meaning that pivot junctions 506 and 516 are urged apart from each other. As described above, in a preferred example, force F is created by a spring contained in pivot junction 506. In the next view, strut 500 is partially open. Angle a is less than 90 degrees, force F is still greater than zero, meaning that strut 500 exerts an opening force on the lid of a cargo carrier. Height H is medium compared to the other views. In the next view, upper arms 508a, 508b and upper pivot junction 516 move down to an over center point in which angle a equals 90 degrees. Force F is zero, and height H is small. In the final view, strut 500 holds a lid in the closed position. Angle a is greater than 90 degrees. Force F is less than zero, meaning that a closing force is exerted on strut 500, i.e., pivot junctions 506 and 516 are urged toward each other. Height H is at a minimum.

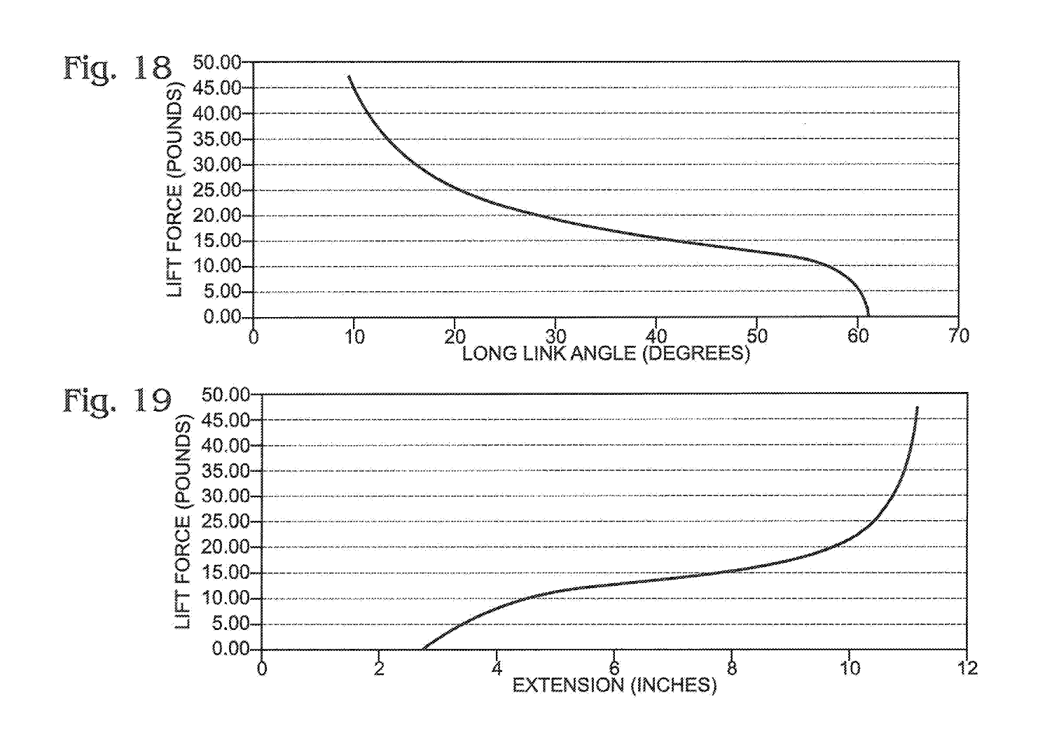

FIGS. 18 and 19 present graphs showing the relationship of lift force with long link angle (degrees) in FIG. 18, and extension (inches) in FIG. 19. The graphs in FIG. 18 and FIG. 19 were constructed based on data generated with a strut configuration similar to those described above. Long link angle is the angle measured between one of the long arms of the strut and an axis which connects the upper and lower pivot junctions. FIG. 18 shows that the lift force decreases as the long link angle increases, reaching a force of zero when the long link angle is slightly over 60 degrees. In FIG. 19, the lift force is zero when the pivot junctions are slightly less than 3 inches apart. The lift force increases as the strut moves toward the open position which is reached when the extension is approximately 11-inches. Each of the graphs in FIGS. 18 and 19 show an increase in force gain near the full extension position of the strut.

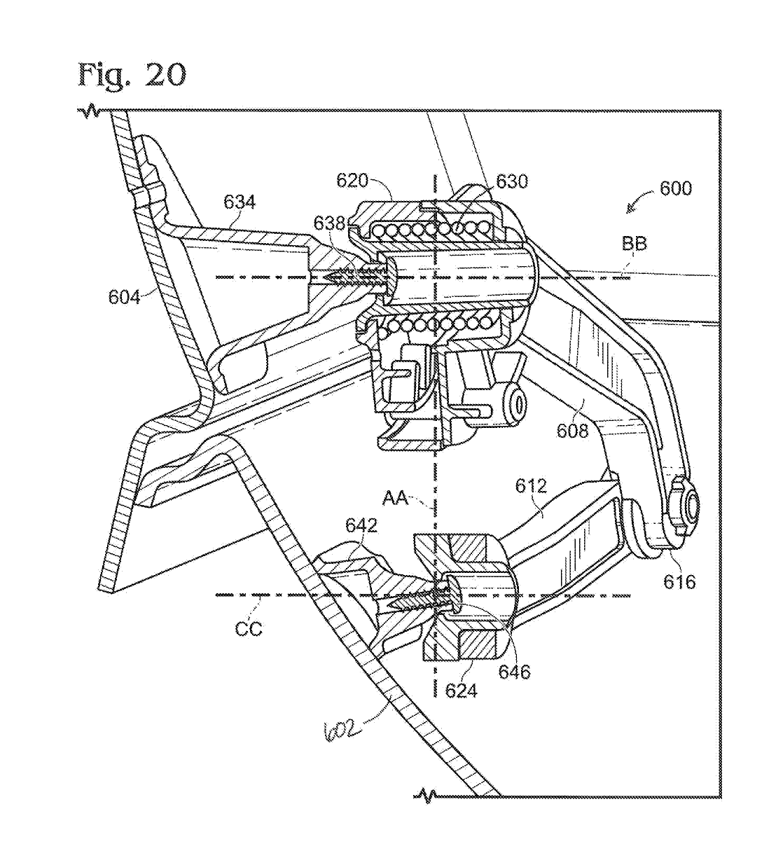

FIG. 20 show a way of mounting strut 600 in a cargo carrier. Strut 600 connects bottom portion 602 to lid portion 604. Strut 600 includes long arm 608 which is pivotally connected to short arm 612 at articulating junction 616. Upper pivot junction 620 is connected to lid 604. Lower pivot junction 624 is connected to bottom portion 602. Pivot junction 620 includes coiled spring 630 for exerting a desired force profile between junction 620 and junction 624 as strut 600 moves between open and closed positions. Mounting base 634 is connected to inner side of lid 604. Pivot junction 620 of strut 600 is connected to mounting base 634 by screw 638. Similarly, mounting base 642 is connected to an inner surface on bottom portion 602. Pivot junction 624 is connected to mounting base 642 by screw 646. Mounting bases 634 and 642 accommodate the curved and irregular contours of bottom portion 602 and lid 604 so that pivot junctions 620 and 624 are substantially aligned with vertical axis AA and horizontal axes BB and CC.

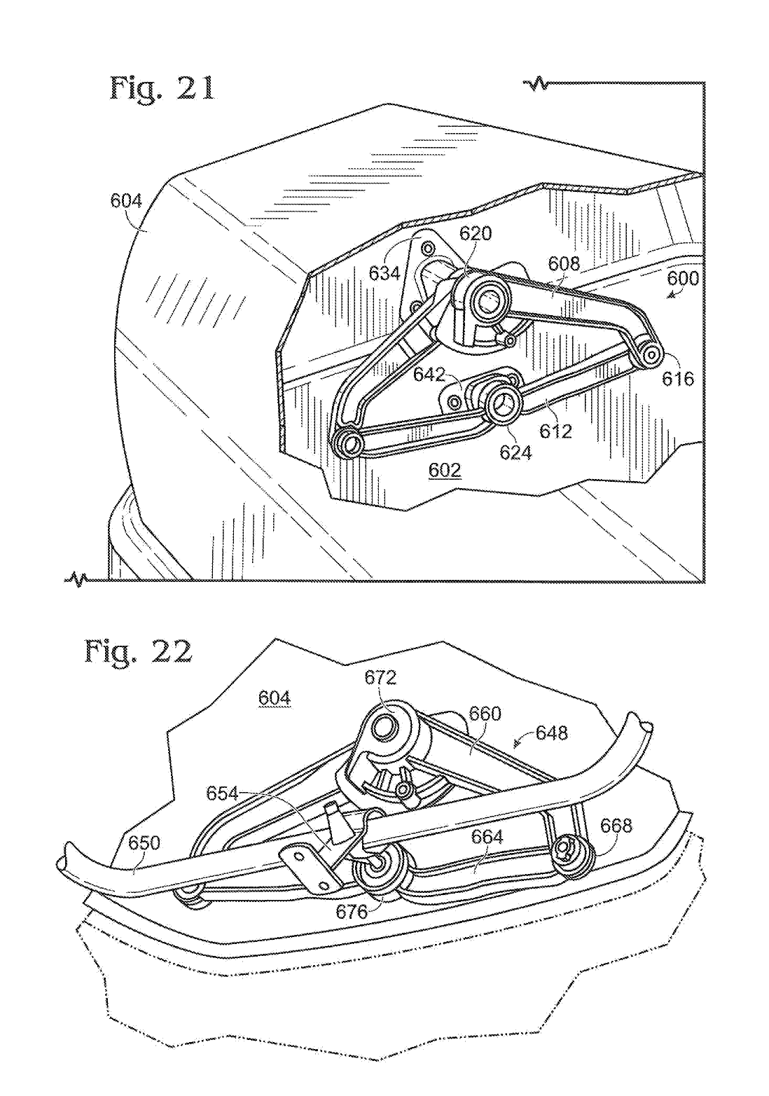

FIGS. 21 and 22 show how struts are mounted on the rear of a box (FIG. 21) and on the front of a box (FIG. 22). In FIG. 21, strut 600 connects bottom portion 602 to lid 604, as described with respect to FIG. 20. The end or backside of the cargo box is shown in FIG. 21. FIG. 22 shows how lid support 648 connects the bottom portion to the lid in the front end of the box. Strut 648 is substantially identical to strut 600, described with respect to FIG. 20 and FIG. 21. In FIG. 22, the bottom portion of the box is removed. Bar 650 is mounted to the bottom portion of the box, partially via coupler 654. Pivot junction 620 is connected to lid 604 via a mounting base, substantially as described with respect to FIGS. 20 and 21. Strut 648 includes long arm 660 connected to short arm 664 at pivot junction 668. Long arm 660 is connected to a corresponding long arm at pivot junction 672. Short arm 664 is connected to a corresponding short arm at pivot junction 676. Pivot junction 672 is connected to lid 604 via a mounting base, substantially as described with respect to strut 600 of FIG. 21. Pivot junction 676 is fastened to coupler 654. The mounting configuration shown in FIG. 22 accomplishes similar goals, as with the rear strut mount, of standardizing the multiple pivoting axes of strut 648, while accommodating irregular angles and contours of the mounting surfaces on the bottom portion and lid of the cargo carrier.

The strut design described above may be considered a four bar linkage with one torsion spring. The design may use four molded plastic links which attach to the box at two points. The upper loop of the lid support may snap over a spherical post on the lid of a cargo carrier. The lower loop of the lid support may snap over a spherical post on the base or bottom of a cargo carrier. Alternatively, the lid support may attach to the lid and base using a screw end post design. As described, the lid support has four pivot points. The lower pivot point may hold a torsion spring. However, it is also possible to mount the lid support in an inverted orientation, thus making the junction including a torsion spring the highest pivot point connected to the lid. The arms of the torsion spring push against the links to bias the lid support to the open position. When the lid support arms are in the lowered position, the arms may push inward which holds the lid support in closed position.

The torsion of the spring may increase as the lid support is compressed into the closed position. However, this may be offset by the increase in horizontal distance between the spring pivots and the elbow pivots. This results in a relatively constant opening force at the mounting loops. This force may increase slightly at the fully open position to give a rigid feel to the box when fully opened.

In a preferred design, a strut assembly, as described above, may be formed from a small number of parts, for example, two lower arms, two upper arms, one drive axle, one torsion spring, and two retaining rings. The lower arm and second lower arm may nest together and contain the torsion spring. The drive axle inserts from one side and is retained in place using a retaining ring. The drive axle and retaining ring may capture the torsion spring and prevent the arms from axially separating. The rivet may provide a hard stop and prevent the arms from twisting apart.

The lifting force of the lid support assembly may be modified by changing the position of one of the arms of the torsion spring. This allows for all the same components to be used to create different assemblies of different lifting forces. The setting of the spring is viewable from the system assembled by looking through the slots or windows on one side of the junction.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A car top carrier comprising
a box having opposing lateral sides, a top, a bottom, a front end, and a rear end, the bottom having a floor, the floor having an inner surface and an outer surface, the top and the bottom being connected by a hinge mechanism along one of the lateral sides, and by a latch mechanism on the other lateral side of the box,
a plurality of clamp devices mounted on the floor of the box configured to secure the box to a pair of crossbars on top of a vehicle, and
a first strut assembly connecting the top to the bottom on the front end of the box, and a second strut assembly connecting the top to the bottom on the rear end of the box, each strut assembly being moveable between open and closed positions and having a biasing device configured to exert a force on the strut member toward the open position, each strut member including a pair of upper arms, each upper arm having a mounting end and an articulating end, the mounting ends of the pair of upper arms being pivotally connected to each other and mounted to the top of the box, each strut member also having a pair of lower arms, each lower arm having a mounting end and an articulating end, the mounting ends of the pair of lower arms being pivotally connected to each other and mounted to the bottom of the box, each articulating end of the pair of lower arms being pivotally connected to a respective articulating end of one of the upper arms, wherein the pairs of arms form a four-bar linkage having two mounting junctions and two articulating junctions, at least one of the junctions having an associated biasing mechanism urging the strut assembly toward the open position, wherein the biasing mechanism includes a coiled spring.

2. The car top carrier of claim 1, wherein each junction has a pivot point, the spring surrounding the pivot point of the respective junction.

3. The car top carrier of claim 1, wherein the biasing mechanism is associated with one of the articulating junctions.

4. The car top carrier of claim 1, wherein the biasing mechanism is associated with one of the mounting junctions.

5. The car top carrier of claim 4, wherein the biasing mechanism is associated with the mounting ends of the upper arms.

6. The car top carrier of claim 4, wherein the biasing mechanism is associated with the mounting ends of the lower arms.

7. The car top carrier of claim 1, wherein each of the mounting junctions has a biasing mechanism urging the respective strut assembly toward the open position.

8. The car top carrier of claim 1, wherein each of the articulating junctions has a biasing mechanism urging the respective strut assembly toward the open position.

9. The car top carrier of claim 1, wherein each of the lower arms is bent near the articulating end.

10. The car top carrier of claim 1, wherein the biasing mechanism is adjustable by altering a seated position of an end of the coiled springs.

11. A car top carrier comprising
a box having opposing lateral sides, a top, a bottom, a front end, and a rear end, the bottom having a floor, the floor having an inner surface and an outer surface, the top and the bottom being connected via hinge mechanisms along the opposing lateral sides of the box, the hinge mechanisms being capable of unlatching allowing the box to be alternately opened on opposing lateral sides of the box,
a plurality of clamp devices mounted to the floor configured to secure the box to a pair of crossbars on top of a vehicle, and
a first strut member connecting the top to the bottom on the front end of the box,
and a second strut member connecting the top to the bottom on the rear end of the box, each strut member being moveable between open and closed positions and having a biasing device configured to exert a force on the strut member toward the open position, each strut member including a first upper arm pivotally connected to the top of the box at a first pivot point, and a first lower arm pivotally connected to the bottom of the box at a second pivot point, each first upper arm being pivotally connected to the respective first lower arm at a third pivot point, wherein the biasing device includes a torsion spring mounted near one of the first or second pivot points.

12. The carrier of claim 11, wherein the torsion spring is mounted near the first pivot point.

13. The carrier of claim 11, wherein the torsion spring is mounted near the second pivot point.

14. The carrier of claim 11, wherein each biasing device includes two torsion springs, one of the torsion springs being mounted near the first pivot point, the other torsion spring being mounted near the second pivot point.

15. The carrier of claim 11, wherein each strut member includes a second upper arm pivotally connected to the first upper arm near the first pivot point, and a second lower arm pivotally connected to the first lower arm near the second pivot point, the second upper arm being pivotally connected to the second lower arm at a fourth pivot point.

16. The carrier of claim 11, wherein each arm has a bend.

17. The carrier of claim 15, wherein each strut member operates symmetrically relative to an axis connecting the first and second pivot points.

18. The carrier of claim 15, wherein each strut member operates symmetrically relative to the third and fourth pivot points.

19. The carrier of claim 11, wherein the strut member exerts a force on the top of the box in an opening direction over the entire range of movement between open and closed positions of the top relative to the bottom of the box.

20. The carrier of claim 11, wherein the strut member exerts a force on the top of the box in two opposing directions alternately between opening and closing of the box.

21. A car top carrier comprising
a box having opposing lateral sides, a top, a bottom, a front end, and a rear end, the bottom having a floor, the floor having an inner surface and an outer surface, the top and the bottom being connected via hinge mechanisms along the opposing lateral sides of the box, the hinge mechanisms being capable of unlatching allowing the box to be alternately opened on opposing lateral sides of the box,
a plurality of clamp devices mounted to the floor configured to secure the box to a pair of crossbars on top of a vehicle, and
a first strut member connecting the top to the bottom on the front end of the box, and a second strut member connecting the top to the bottom on the rear end of the box, each strut member being moveable between open and closed positions and having a biasing device configured to exert a force on the strut member toward the open position, each strut member having a shoulder pivot connected to the top of the box and a wrist pivot connected to the bottom of the box, the biasing device including at least one torsion spring positioned around either the shoulder pivot or the wrist pivot, wherein the strut member operates substantially symmetrically relative to an axis passing through the shoulder pivot and the wrist pivot.

22. The carrier of claim 21, wherein the biasing device includes two torsion springs, one torsion spring being located around each of the shoulder and wrist pivots.

23. The carrier of claim 21, wherein each strut member includes two arm assemblies, each arm assembly having an upper arm connected to the shoulder pivot and a lower arm connected to the wrist pivot, the upper and lower arms being connected at an elbow pivot.

24. The carrier of claim 23, wherein the upper arm of one of the arm assemblies is an identical part to the lower arm of the other arm assembly, the lower arm of said one of the arm assemblies being identical in form to the upper arm of the other arm assembly.

25. The carrier of claim 11, wherein the strut members exert forces on the top of the box in an opening direction over the entire range of movement between open and closed position of the top relative to the bottom of the box.

26. The carrier of claim 11, wherein the strut members exert forces on the top of the box in two opposing directions alternately toward opening and closing of the box.
